(19) United States
(12) Patent Application Publication
(10) Pub. No.: US 2007/0175598 A1
(43) Pub. Date: Aug. 2, 2007

(54) Slat-pulling device for a venetian blind

(76) Inventor: Jin-Tang Hung, Chiayi City (TW)

Correspondence Address: BIRCH STEWART KOLASCH & BIRCH, PO BOX 747, FALLS CHURCH, VA, 22040-0747, US

(21) Appl. No.: 11/341,492

(22) Filed: Jan. 30, 2006

(51) Int. Cl. E06B 9/30

(52) U.S. Cl. 160/168.1 R

(57) ABSTRACT

The present invention discloses a slat-pulling device for a Venetian blind, which comprises a rectangular frame, wherein multiple slats are arranged from top to bottom inside the frame; and the left and right ends of each slat are respectively pivotally coupled to the frame so that each slat can rotate freely. The improvement of the present invention is: the left and right sides of the slats are respectively linked to annular fabric ribbons; and rotating an arbitrary slat can synchronically drive all the slats to tilt, shut, or open.

### FIELD OF THE INVENTION

The present invention relates to a linkage structure for opening and shutting a Venetian blind, particularly to a simple-structure linkage device, which can synchronically drive all the slats of a Venetian blind to shut or open.

### BACKGROUND OF THE INVENTION

Refer to FIG. 1 and FIG. 2 diagrams showing the structure of a conventional Venetian blind. The conventional Venetian blind 1 comprises a frame 2; multiple slats 3 are arranged by intervals inside the frame 2; the left and right ends of the slat 3 are respectively pivotally installed to the frame 2 so that the slats 3 can rotate; those slats 3 are commonly coupled to a pulling rod 4, and the pulling rod 4 is installed to the central portion of the front sides of those slats 3. As shown in FIG. 2, merely pulling down the pulling rod 4 will enable the slats 3 to tilt downward synchronically and overlap just like stacked fish scales so that external light can be blocked out. When the pulling rod 4 is lifted upward, the tilted slats 3 will be restored to orient horizontally so that external light and air can enter into the room via the gaps between the slats 3.

As the pulling rod 4 has a considerable weight, the gravity of the pulling rod 4 is apt to pull the slats 3 away from their horizontal positions and tilt the slats 3 obliquely; thus, the slats 3 are hard to maintain horizontal. Besides, as the width of the slat 3 is greater than the spacing between two slats 3, it is impossible to completely close the gaps between the slats 3; even though the pulling rod 4 has been pulled down to the limit, light and wind is still hard to block completely.

Based on many years' experience of fabricating and selling related products, and with persistent study and experiments, the Inventor can finally proposes a highly practical invention to overcome the problem of incomplete closure of the conventional Venetian blind.

### SUMMARY OF THE INVENTION

The primary objective of the present invention is to provide a slat-pulling device for a Venetian blind, which comprises a rectangular frame, wherein multiple slats are arranged from top to bottom inside the frame; and the left and right ends of each slat are respectively pivotally coupled to the frame so that each slat can rotate freely. The improvement of the present invention is: the left and right sides of the slats are respectively linked to annular fabric ribbons; rotating an arbitrary slat can synchronically drive all the slats to tilt, shut or open; such a design is simple but effective enough to block light and wind.

### BRIEF DESCRIPTION OF THE DRAWINGS

FIG. 1 is a perspective view of an opened conventional Venetian blind.

FIG. 2 is a perspective view of a closed conventional Venetian blind.

FIG. 3 is a perspective view of a preferred embodiment of the present invention.

FIG. 4 is a perspective view showing tilted slats according to a preferred embodiment of the present invention

FIG. 5 is a perspective partial exploded view of a preferred embodiment of the present invention.

### DETAILED DESCRIPTION OF THE PREFERRED EMBODIMENTS

To enable the characteristics, objectives, and efficacies of the present invention to be thoroughly understood and recognized, a preferred embodiment of the present invention is to be described below in cooperation with the drawings.

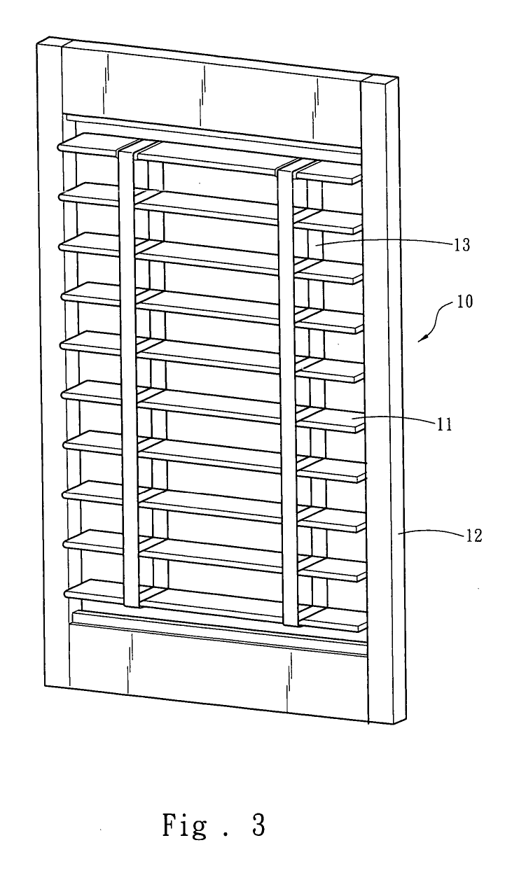

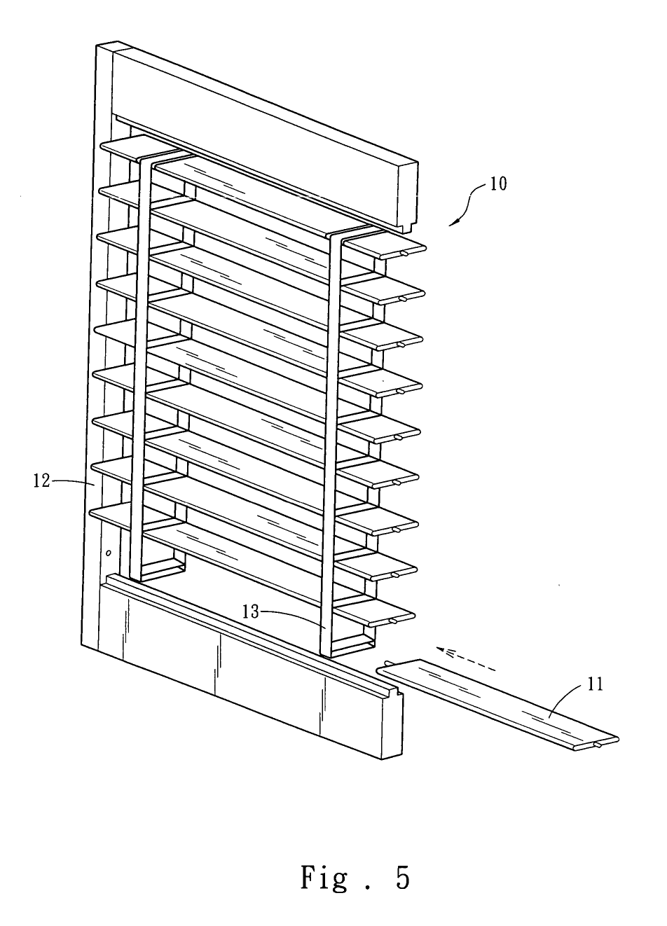

Refer to from FIG. 3 to FIG. 5. The slat-pulling device for a Venetian blind of the present invention comprises a rectangular frame 10; multiple slats 11 are disposed sequentially from top to bottom by intervals inside the frame 10; the right end and left ends of each slat 11 are respectively pivotally installed to the left and right bars 12 of the frame 10 so that each slat 11 can rotate freely to an intended angle; the left and right sides of the slats 11 are respectively installed to annular fabric ribbons 13, and all the slats 11 are interlinked in the rear sides and front sides by the fabric ribbons 13. Rotating an arbitrary slat 11 can drive all the slats 11 to rotate simultaneously, and thus, the slats 11 can be tilted, shut, or opened synchronically.

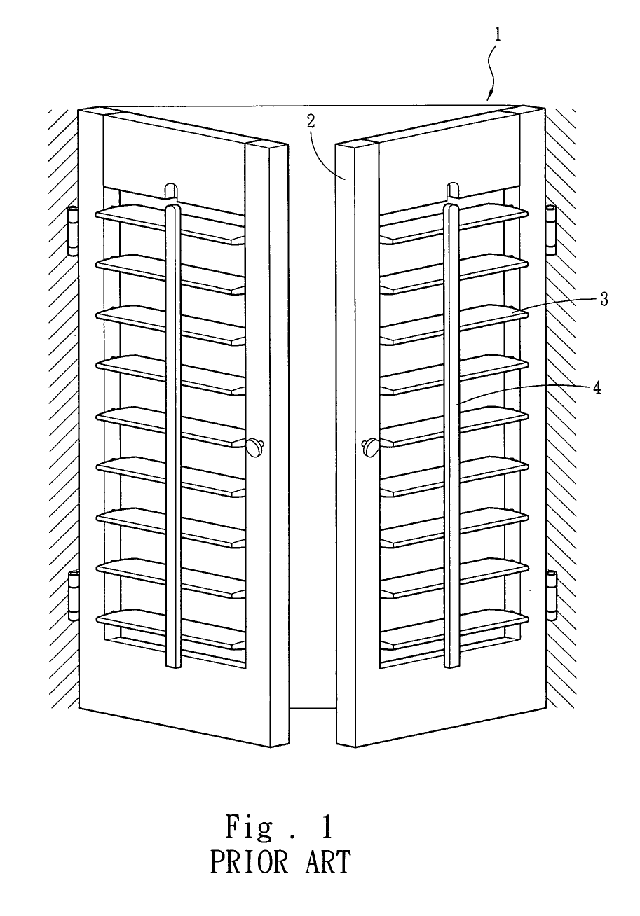

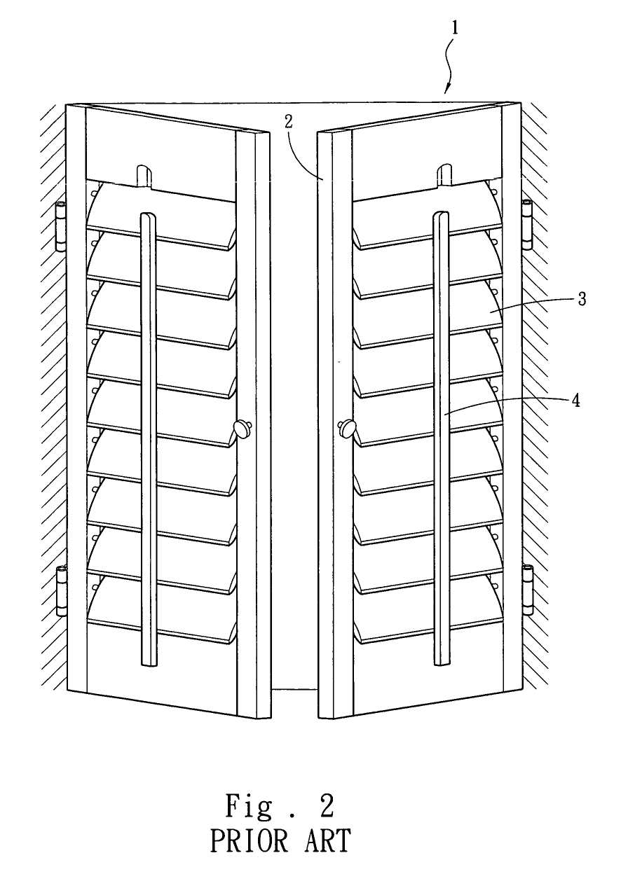

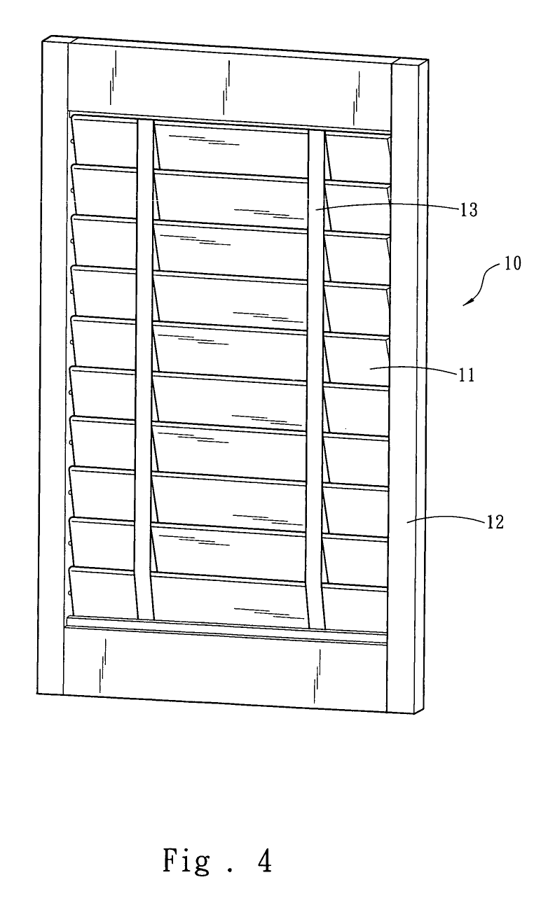

As the fabric ribbons 13 are made of a flexible material, they can rotate with the slats 11 without any confinement. Thus, as shown in FIG. 4, when the slats 11 rotate to obliquely tilt with bottom overlapping top, the flexible annular fabric ribbons 13 can also rotate synchronically with the slats 11 without any retard. The slats 11 oriented horizontally will not be pulled down by the gravity of the fabric ribbons 13, and the Venetian blind can be full permeable to the wind. In comparison with the conventional Venetian blind shown in FIG. 1 and FIG. 2, the present invention has the following advantages: firstly, external light can be completely blocked out from the room, and the wind-proof function is also better; secondly, the slats 11 oriented horizontally are unlikely to tilt unintentionally, and the gap between two slats 11 can be full open, so that abundant external light can enter into the room and ventilation effect is also better; thirdly, as the fabric ribbons 13 are very lightweight, they almost do not increase the weight of the entire Venetian blind.

The present invention has been submitted above. The sample of the present invention has been proved to be able to achieve the expected objectives and efficacies via repeated tests; thus, the utility of the present invention should have a superior market potential. As far as the present invention is intended to apply for a patent, the related or similar products have not been found in publications or markets yet. Therefore, the present invention is filed for a patent.

That described above is only a preferred embodiment of the present invention, and it is not intended to limit the scope of the present invention; any equivalent modification and variation according to the claims of the present invention is to be also included within the scope of the claims.

What is claimed is:

1. A slat-pulling device for a Venetian blind, comprising a rectangular frame, wherein multiple slats are arranged from top to bottom inside said frame; left and right ends of each said slat are respectively pivotally coupled to left and right bars of said frame so that each said slat can rotate freely; and the left and right sides of each said slat are respectively linked to annular fabric ribbons.
